(19) United States
(12) Patent Application Publication
(10) Pub. No.: US 2001/0046042 A1
(43) Pub. Date: Nov. 29, 2001

(54) Device for speed measurement

(76) Inventors: Horst Theile, Aachen (DE); Franz Wosnitza, Aachen (DE); Bernhard Puttke, Herzogenaurach (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/812,523

(22) Filed: Mar. 20, 2001

(30) Foreign Application Priority Data
Mar. 20, 2000 (DE) 100 13 512.9

(51) Int. Cl. G01P 3/36

(52) U.S. Cl. 356/28

(57) ABSTRACT

The invention relates to a device for speed measurement with two sensors arranged at a predetermined distance from each other in a direction of movement of an object and arranged at a distance from the surface of the object, which emit signals to an evaluation device with two input channels, the evaluation device being a delay correlator which digitizes the signals occurring at its input channels and forms a closed control loop for determining the time shift of the signals emitted by the sensors, the control loop having a phase detector for a comparison of the time shift of input signals, a controller and an adjusting circuit for the controlled variable or parameter to be controlled by the controller, the delay correlator having a shift register of a constant length and variable clock frequency, wherein a phase comparison of the instantaneous values of the digitized signals of the two sensors, one of which is delayed by the controller, can be performed by the phase detector, the clock frequency of the shift register being adjustable by the controller in a way corresponding to the delay from which the speed results.

### FIELD OF THE INVENTION

The invention relates to a device for speed measurement as it may be used for industrial processes.

In many branches of industry, the recording of speed and the analysis of movements forms an indispensable part of process control, process optimization and the controlling of events critical for production. The determination of speeds often takes place indirectly by measuring the number of revolutions or other variables or parameters linked with speed by means of optical or magnetic pulse generators. The often restricted accessibility of moving parts and the measuring errors caused by slip and wear in many cases no longer allow the use of mechanically coupled measuring systems, but require a contactless method of measuring speed. A simple method for this is measuring the delay of an object of which the speed is to be determined between two well-defined points, for example between two light barriers arranged one behind the other.

However, there are a growing number of industrial and commercial applications in which these methods can no longer be used. Examples of these are

running strips of sheet metal, paper etc. with sensitive surfaces,

bulk products moved by means of vibrating conveyors,

vehicles with great slip, for example in the sport of go-karting or tractors,

vehicles with traction control,

flowing liquids, open channels,

ascertainment of the stretching of rolled stock by measuring the speed upstream and downstream of the rolling stand.

### BACKGROUND OF THE INVENTION

U.S. Pat. No. 4,912,519 discloses a device for speed measurement in which two sensors arranged at a predetermined distance from each other in a direction of movement of an object and arranged at a distance from the surface of the object are provided. The signals of the two sensors are evaluated in a delay correlator with two input channels, which digitizes the input signals and forms a closed control loop for determining the time shift of input signals. In this case, the controlling of the delay correlator takes place by means of cross-correlation coefficients, the delay for coincidence determination being carried out by means of two shift registers, the clock frequency of which is variable, in order to determine a maximum of the cross-correlation function. For this purpose, a time-based quantization is performed and it is established how often instantaneous values coincide. The further the maximum of the cross-correlation function is away from the range being considered at a given instant, the worse this method works, since the window to be observed has to be shifted accordingly. Therefore, in the case of low speeds, this binary signal correlation by the delay method can only follow small accelerations. In the case of high speeds, it tends to give incorrect measurements; not to mention the fact that a device of this type requires relatively high expenditure on hardware.

German patent application published under No. 4 225 842 discloses a device for measuring the speed of textile filaments on a winding device in which a delay correlator circuit is likewise used, it being attempted in this way to deal with the problem of the speed dependence of the measuring error by performing a controlling adjustment by an additional external signal in order to supply a range presetting for locking the control loop onto the correct dead-time maximum.

### SUMMARY OF THE INVENTION

It is an object of the invention to provide a device for speed measurement with which the speed at a given instant can be measured contactlessly.

It is a further object of the invention to provide a device which allows speed measurement with respect to any desired surface in real time.

It is still a further object of the invention to provide a device which allows speed measurement over a very large speed range with great accuracy and without incorrect measurements occurring.

It is yet another object of the invention to provide a delay correlator for a measuring device which allows a measurement with great accuracy.

It is still another object of the invention to provide a delay correlator which provides a measurement with great accuracy in a device for speed measurement.

The invention involves a phase detector performing a phase comparison of the instantaneous values of the digitized signals of two sensors, one of which is delayed by a controller having a shift register with a variable clock frequency, the clock frequency of the shift register being adjustable by the controller in a way corresponding to the delay from which the speed results. The clock frequency in this case determines the pulse duration of the system deviation and is set such that the digitized signals of the two sensors are no longer different, i.e. the controller sets the clock frequency to bring about a corresponding signal delay. The undelayed signal and the delayed signal are then compared with each other in terms of phase, i.e. the edges are evaluated, i.e. the respective change in state is established. Consequently, the direction of the system deviation and the speed are coded via the pulse duration of the signals. Accordingly, an event comparison takes place, in contrast with the determination of a maximum of a cross-correlation function.

The delay correlator can be realized in a particularly advantageous and simple way by a configurable FPGA.

Further objects, embodiments and advantages of the invention will become apparent from the following description and the claims.

### BRIEF DESCRIPTION OF THE DRAWINGS

The invention will be explained in more detail below with reference to of preferred embodiments illustrated schematically in the appended drawings.

FIG. 1 schematically shows the measuring principle according to the invention.

FIG. 2 shows typical signals as they are picked up by sensors of a device according to the invention for speed measurement.

FIG. 3 shows a block diagram of a delay correlator for a device according to the invention for speed measurement.

FIG. 4 shows the conversion of an analog signal S(t) into a binary signal B(t) by the delay correlator of FIG. 3.

FIG. 5 shows an embodiment of FIG. 3.

FIG. 6 illustrates the difference in delay between two binary signals.

FIG. 7 illustrates the change in the controller output.

FIG. 8 schematically shows an example of signal recording.

FIG. 9 schematically shows as a block diagram a device for controlling speed/rotational speed.

FIG. 10 schematically shows as a block diagram a device for measuring rotational speed.

### DETAILED DESCRIPTION OF PREFERRED EMBODIMENTS

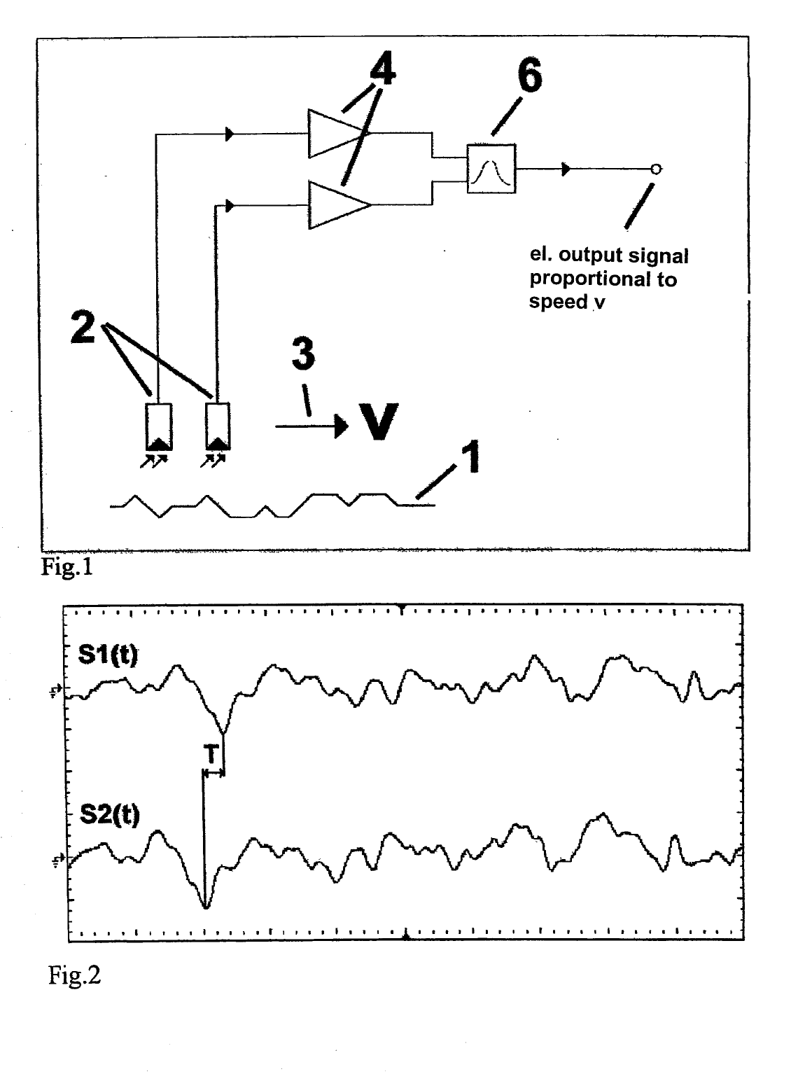

As represented in FIG. 1, a surface 1 of an object moving at a relative speed ν is scanned by means of two suitable sensors 2 at two points which are arranged at a defined distance L one behind the other in the direction of movement according to arrow 3. The signals generated by the sensors 2 are stochastic signals. These signals are similar, in an ideal case identical, but shifted with respect to each other by the delay T, cf. FIG. 2. With the known distance L of the points scanned by the sensors, the speed can be calculated from the delay T:

$$v = \frac{L}{T}$$

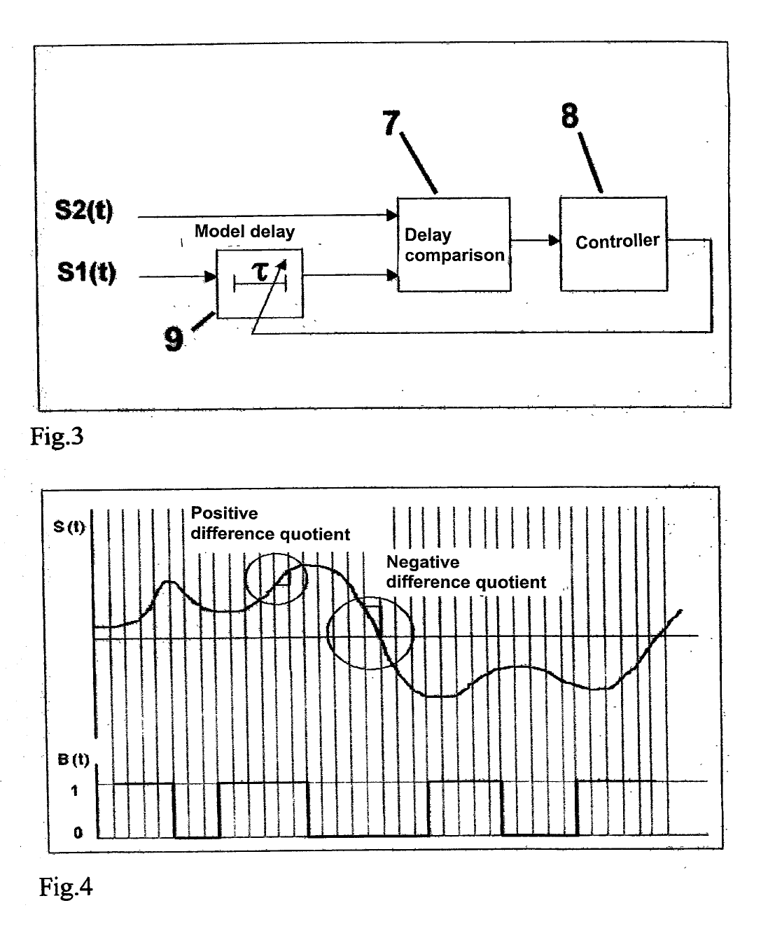

For this purpose, the sensors 2 are connected via signal amplifiers 4 to an evaluation device in the form of a delay correlator 6, which forms a closed control loop for determining the time shift of the signals emitted by the sensors 2. As represented in FIG. 3, the delay correlator 6 comprises a device 7 for comparing the delay of applied signals, a controller 8 and a device 9 for adjusting a variable or parameter to be controlled by the controller 8. In the delay correlation, the time shift T of the received signals s₁(t) and s₂(t) is determined by means of the closed control loop. In an ideal case, with maximum similarity, s₂(t)=s₁(t−T).

The system behavior between two receivers is considered as a transporting process with a time shift T. This time shift T is compared within the delay correlator 6 with a model delay τ as a controlled variable. This model delay τ is changed and corrected in such a way that the difference between the signals

e(t)=s₂(t)−s₁(t−τ)

in the quadratic sense assumes a minimum, i.e.

E{(s₂(t)−s₁(t−τ))²}=min.

The necessary condition for a minimum is

$$\frac{ⅆ}{ⅆ τ} E \{ {( {s}_{2} ( t ) - {s}_{1} ( t - τ ) )}^{2} \} = - 2 E \{ ( {s}_{2} ( t ) - {s}_{1} ( t - τ ) ) * \frac{ⅆ}{ⅆ τ} {s}_{1} ( t - τ ) \} = 0.$$

Since the distribution density functions of s₁(t) and s₂(t) are unknown, the mean value is used here as an estimated value for the expected value. Under this boundary condition, it is then adequate to calculate only the derivative of the correlation function at one point at the model delay τ. At the point T sought, there is a zero crossing. To the right and left of this zero crossing, the mean value has different algebraic signs. The behavior of the mean value thus corresponds to that of a system deviation within a normal control loop. Consequently, a simple control loop can be set up for τ. When the control loop is calibrated, τ=T, and the output variable of the controller represents a direct measure of the time shift or delay sought.

One advantage of the delay correlation method, in contrast with the cross correlation, is the distinctly reduced computing effort. This significantly favors a hardware way of realizing the delay correlator 6, so that online and real-time evaluation is made possible.

An additional simplification of the technical way of realizing the delay correlator 6 is achieved by quantization of the signals to 1 bit. Consequently, binary signals, i.e. only the two possible signal states “0” and “1”, are used for the correlation analysis.

Customary coding methods use simple comparator circuits and generate a binary output signal in dependence on the polarity of the instantaneous value of the analog input signal. Therefore, this is also referred to as polarity correlation. In this technical way of realizing it, known as “clipping”, part of the information contained in the signals s₁(t) and s₂(t) is lost however, as a result of which the information density available is considerably reduced, so that for example complex interference methods, in which information on the phase relationship of the signals is additionally evaluated, are arranged upstream in order to increase the information density.

Used with preference in the digitizing of the signals in the delay correlator 6 is an electronic circuit which codes the algebraic sign of the difference quotient of the analog input signal, cf. FIG. 4, which illustrates this transformation from the analog function S(t) to the binary function B(t). Here, a logical “1” means a rising signal and a logical “0” means a falling signal. This coding results in a significantly increased information content of the binary signals. This has the effect on the one hand of significantly lower requirements for the preparation of input signals and consequently for the necessary technical equipment, and on the other hand that the dynamic behavior of the delay correlator 6 improves, in particular in the analysis of relatively slow movements.

The use of sample-and-hold circuits (not represented) for producing the difference quotient, with one or more sample-and-hold circuits per input channel, allows a high degree of synchronism of the two channels of the delay correlator 6 to be ensured. An additional dissimilarity of the two binary signals, as occurs when using differentiating elements due to variance of the component values, is avoided in this way.

The delay correlator 6 is realized by means of a FIELD-PROGRAMMABLE-GATE-ARRAY (FPGA), so that a highly integrated and flexible evaluation unit is obtained. Programmable logic components such as FPGAs offer the possibility of realizing digital circuits with a high integration density and a high degree of flexibility. FPGAs which can have circuits of up to one million logic gates are currently available. At the same time, this architecture makes it very much easier to switch to mass production with large numbers of units and to use ASICs and allows the subsequent ASIC development to be much faster and less costly.

The circuit inside an FPGA is created by programming connections between individual logic cells and input/output cells. An FPGA can be programmed as often as desired, so that new circuits can be implemented over and over again.

In the present case, this means that changes in the system properties can be carried out by reprogramming the FPGA. The actual hardware remains unaffected by this. That is to say, neither the PCB layout nor the component insertion of the associated PCB have to be changed.

This makes it possible to realize a configurable delay correlator 6 as a closed binary system. In its minimum configuration, this has two binary inputs for feeding in the sensor signals and one binary output for outputting the measurement result. For the output, a frequency-coded signal of which the output frequency behaves proportionally to the measured speed can be generated. Each edge change of the output signal consequently corresponds to an established part of a path, so that, by counting the edge changes by means of a downstream counter, a length measurement can also be additionally realized in a simple way.

For comparison of the two signal delays, i.e. the time shift T of the signals received, a phase detector 7 is expediently used, as known for example from PLL circuits. The output signal of the phase detector 7 is used as a measure of the system deviation for activating the downstream controller 8. In addition to simplifying the circuit, the use of a phase detector 7 achieves improved dynamic behavior of the delay correlator 6.

The controller 8 in the delay correlator 6 has the task of setting the model delay such that the difference in the delay of the two signals at the input of the phase detector 7 is zero. In order that the delay correlator 6 can also follow rapid changes in speed, the controller 8 must perform this in as short a time as possible. This is achieved by being able to choose the structure and the parameters of the controller 8 optimally for the respective measuring task within a wide range as a result of using the flexible electronic circuit with FPGA.

The controller 8 provides at its output an amplitude-quantized actuating signal with adequate digital resolution. This signal represents the controller output in the closed control loop of the delay correlator 6 and behaves proportionally to the measured speed.

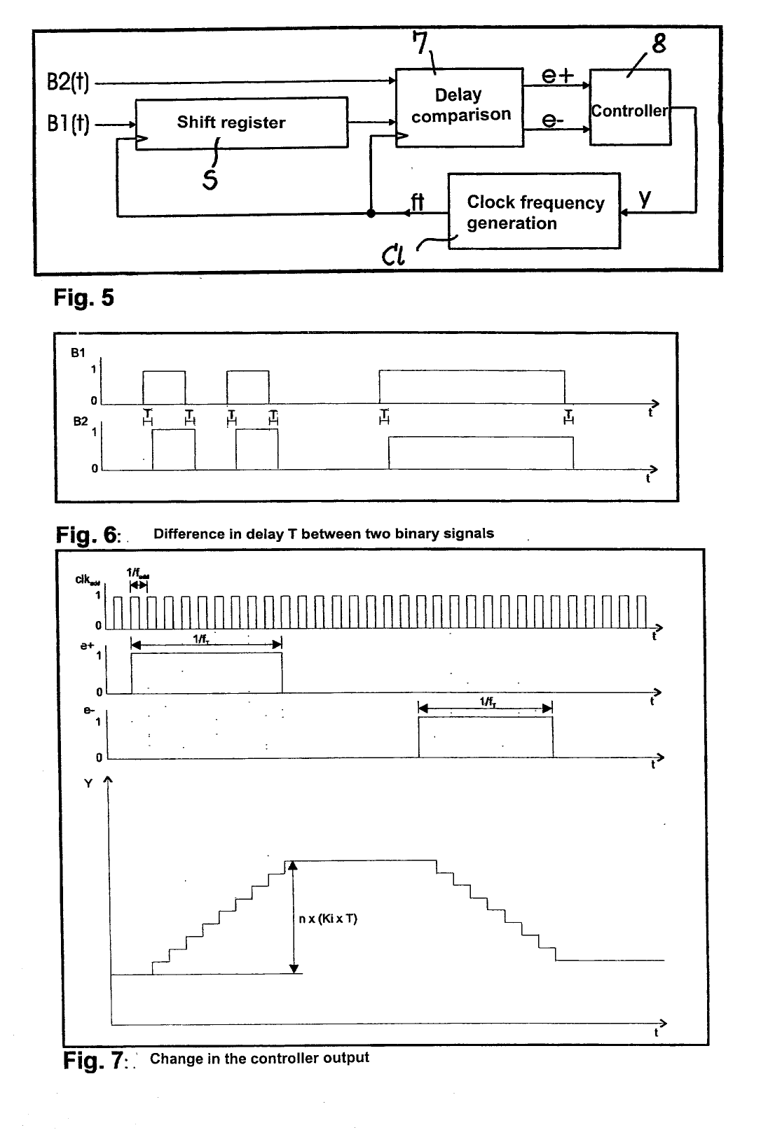

To generate the model delay, a shift register S may be used, cf. FIG. 5. Here there are in principle two possibilities for setting the delay.

Firstly, with a constant clock frequency, the number of shift register stages can be changed. In this case, the model delay is always a multiple of the period duration of the clock frequency. This method is suitable for microprocessor-based correlators, since they are easy to implement by means of software.

The other possibility for setting the model delay a, preferred in the case of a delay correlator 6 based purely on hardware, is that of changing the clock frequency with a constant shift register length. Preferred here for clock frequency generation is a clock frequency generator Cl which uses the DDFS (direct digital frequency synthesis) method, which generates a frequency which is linear in relation to the digital input signal. The output signal of the controller 8 is then used as the digital input signal.

A special feature is that the variable clock frequency of the shift register S is used at the same time for the clock control of the controller 8. Since the clock frequency is then speed-dependent, the controller parameters automatically change with the changing of the measured speed. Consequently, the dynamic behavior of the delay correlator 6 adapts itself to the dynamics of the speed investigated.

The bandwidth of the digitized signals generated by the sensors 2 is dependent on the size of the scanned surface areas and the speed ν. In the case of low speeds, the bandwidth of the signals decreases. At a standstill ν=0, the alternating component of the signals tends toward zero. This means for the delay correlator 6 that the frequency of the binary signal edges is lower in the case of low speeds than in the case of high speeds.

In the case of a delay correlator with a closed control loop, a signal for the system deviation which corresponds to the difference in delay of the two binary signals B1 and B2 must be generated. Since binary signals only have the two states ‘0’ and ‘1’, a delay difference between two binary signals can take place by “observing” the changes in state. FIG. 6 illustrates this situation.

In order that a controller can change its output variable, the controller output y, it requires at its input an input signal other than zero, the system deviation e. It follows directly from this that, in the case of low speeds, the controller can change the controller output less frequently and consequently can also change the measured value for the speed less frequently.

Assuming that the system deviation were a direct measure of the delay difference e≈T, the consequence would be that only the measuring rate would decrease with the speed. Since, however, circuits for generating the system deviation e that are feasible in terms of circuit engineering can only ascertain the algebraic sign of e, here there is the risk that, in the case of a low speed, the delay correlator 6 can no longer follow rapid changes in speed.

If the cross-correlation function is used as a hypothesis for describing the resulting behavior of the delay correlator, the conclusion is reached that there is then the risk of the delay correlator “locking” onto a secondary maximum of the cross-correlation function. This can also happen in the case of high speeds if the controller is set in such a way that it can follow accelerations well in the case of low speeds.

Therefore, in addition to the algebraic sign, the speed measured at the given time is used for coding in the signal of the system deviation, in order in this way to make the setting of the controller (the controller parameters) speed-dependent. This solution makes it possible with extremely little additional expenditure on circuitry to overcome the problem described above and does not restrict varied use of the delay correlator, since no additional signal generators are required.

The use of a digital integrator as the controller is described below by way of example. It is known that such a controller is described by the differential equation

yₖ=yₖ₋₁+eₖ₋₁·(Kᵢ·T), (1)

where yₖ corresponds to the controller output to be newly calculated, yₖ₋₁ corresponds to the current controller output, eₖ₋₁ corresponds to the current system deviation, Kᵢ corresponds to the integration constant and T corresponds to the period duration of the clock frequency.

If a time shift of the two binary signals were then detected and only the algebraic sign of the system deviation were coded, eₖ₋₁ would assume the value 1 or −1 for the duration T. This results in a change in the controller output of |Δy|=Kᵢ·T.

In the present case, however, the system deviation is coded with the two bits e+ and e−. The following rules apply here:

The bit e− is set if the model delay τ is set too low.

The bit e+ is set if the model delay τ is set too high.

Both bits remain set for the duration of one period of the shift register clock frequency f_{T} and are reset when the setting condition is no longer satisfied.

Since f_{T} behaves proportionally to the speed ν,

$${f}_{T} = \frac{v}{{K}_{v}} ,$$

this type of coding gives for e+ and e− a speed-dependent pulse duration Tₚ.

$${T}_{p} = \frac{1}{{f}_{T}} \approx \frac{1}{v}$$

If the addition in the I-controller is now clock-controlled with a significantly higher constant frequency f_{add}, precisely

$$n = \frac{{f}_{add}}{{f}_{T}} \approx \frac{1}{v}$$

additions are performed during the duration of a pulse duration Tₚ, i.e. the controller output changes by

$$\vert Δ y \vert = n \cdot ( {K}_{i} \cdot T ) \approx \frac{1}{v} .$$

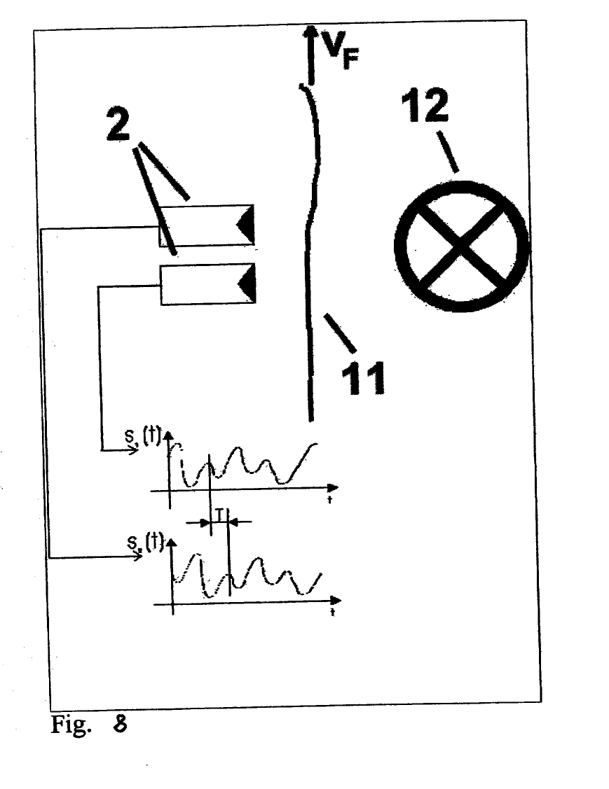

Compare FIG. 7 in this respect.

As a result, the contoller output changes much more strongly in the case of low speeds than in the case of high speeds and the influence of the decreasing edge frequency is compensated.

Using ν=K_{ν}·f_{T}, the expression

$$n \cdot {K}_{i} = \frac{{f}_{add}}{{f}_{T}} \cdot {K}_{i}$$

can be summarized as a new speed-dependent integration constant

$${K}_{i}^{′} ( v ) = {K}_{i} \cdot {K}_{v} \cdot {f}_{add} \cdot \frac{1}{v}$$

Practice clearly shows that delay correlators 6 operating in this way are better able to follow accelerations over the entire measuring range and produce more precise measuring results than delay correlators with constant controller parameters.

Since not only the binary output signal but also a digital signal is available internally in the FPGA of the delay correlator 6 as a measure of the delay measured, additional parts of the circuit can easily be implemented at the same time as part of the FPGA. As a result, the delay correlator 6 can be adapted optimally for the respective intended use. Here are some examples:

digital interface for outputting the controller output as a direct measure of the speed/rotational speed measured, for example: interface according to RS232/RS485,

digital interface for outputting the length measured,

digital interface for inputting system parameters,

digital interface for activating a D/A converter for analog speed output,

integration of a counter for the length measurement,

generation of a CUT signal for cutting to a preset length,

realization of a direction identification (forward and rearward directions),

combination of a number of delay correlators 6 for vectorial speed/displacement measurement,

alarm outputs for signaling the exceeding of limit values,

additional binary inputs for signaling the beginning/end in length measurement.

Use of the device is particularly suited for the length measurement of, for example, endless material in the form of webs, filaments or the like with a particularly sensitive surface, since it ensures a contactless mode of operation. Disadvantageous impairment of the condition of the surface, and consequently of the quality of the material, is avoided.

As represented in FIG. 8, two contactlessly operating optical sensors 2 (referred to hereafter as conjugate) of a sensor unit which are arranged at a distance L (centroids) from each other in the direction of movement of an endless material 11 are provided opposite a source of illumination 12, the endless material 11 running through between the sensor unit and the source of illumination 12. The two conjugate sensors 2 produce stochastic signals s₁(t) and s₂(t), which reflect the surface structure of the endless material 11 (accordingly, the type of material of the object to be monitored has a significant influence on the selection of the sensors 2). The signals are further processed in the delay correlator 6.

The delay correlator 6, as the signal processor, has the task of ascertaining the time shift T of the input signals. By integration over the speed ν_{F} thus determined, the length of material can be determined. If the desired length is reached, the conveying operation is stopped or the material is severed.

In an embodiment not shown, two pairs of conjugate sensors are provided, the joining axes forming a known angle, expediently 90°. The two pairs of sensors particularly allow speed components in two directions of movement to be recorded simultaneously, so that the speed can be ascertained vectorially in two dimensions. Instead of two pairs of sensors, three individual sensors may also be provided, two in each case being conjugate in relation to each other.

In a corresponding way, the device may be used as an “intelligent” light barrier, which detects from which direction an object sensed by it is coming, how quickly it is moving and how long it is.

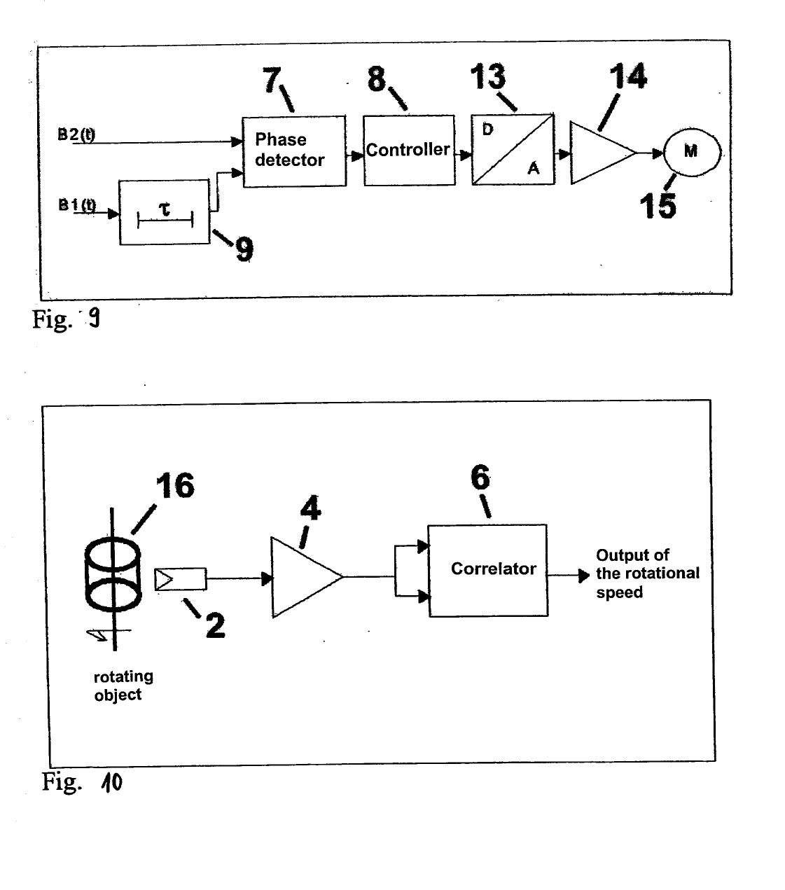

The special structure makes the delay correlator 6 suitable with only minor modifications with respect to the normal configuration as a speed controller or rotational speed controller, as evident from FIG. 9. For this purpose, the model delay is set to a fixed value which is in a fixed relationship via

$$τ = \frac{L}{{v}_{soll}}$$

with the desired speed (rotational speed). With the aid of the phase detector 7, in the case of a system deviation a difference in delay is established between the signal delay and the model delay and the downstream controller 8 is activated in such a way that the speed is corrected. In this case, the binary functions B₁(t) and B₂(t), obtained from the analog functions s₁(t) and s₂(t), are preferably used. To make this possible, a signal for activating motor electronics 14 of a motor 15 is generated from the digital output signal of the controller 8 using a D/A converter 13.

The delay correlator 6 can also be readily used for rotational speed measurement, as evident from FIG. 10. For this purpose, all that is required is a measured value pick-up, for instance an optical detector, which scans the surface of a rotating object 16 and consequently generates a periodic signal. The amplified and digitized measuring signal is passed to both inputs of the delay correlator 6.

With the correct choice of system parameters, the delay correlator 6 sets itself to the delay T, which corresponds here to the period duration of the input signal.

$$T = \frac{1}{N}$$

where N is the rotational speed in s⁻¹

$${f}_{aus} \approx \frac{1}{T} ⇒ {f}_{aus} \approx N$$

The delay correlator 6 consequently generates an output signal of which the frequency behaves proportionally to the rotational speed.

Depending on the condition of the surface of the object of which the speed is to be measured, different sensors, for example optical sensors, ultrasonic sensors, microwave sensors etc., can be used. In flowing media, for example, the correlation method described above can be advantageously used for multidimensional ultrasonic speed measurement, it also being possible for the delay method to be realized as the phase comparison method.

What is claimed is:

1. A device for speed measurement comprising:
two sensors arranged at a predetermined distance from each other in a direction of movement of an object and arranged at a distance from the surface of the object,
an evaluation device with two input channels receiving signals emitted by the sensors, the evaluation device being a delay correlator which digitizes the signals occurring at its input channels and forms a closed control loop for determining a time shift of the signals emitted by the sensors,
wherein the control loop has a phase detector for comparing the time shift of input signals, a controller and an adjusting circuit for a parameter to be controlled by the controller,
wherein the delay correlator has a shift register of a constant length and variable clock frequency,
wherein a phase comparison of the instantaneous values of the digitized signals of the two sensors, one of which is delayed by the controller, is performed by the phase detector, and
wherein the clock frequency of the shift register is adjustable by the controller in a way corresponding to the delay from which the speed results.

2. The device of claim 1, wherein the delay correlator is realized as a configurable FPGA.

3. The device of claim 1, wherein a model delay serving as a parameter is controllable by the controller such that it is equal to the signal delay of the signals of the input channels.

4. The device of claim 1, wherein the delay correlator comprises an electronic circuit which codes in binary form the algebraic signs of the difference quotient of the analog input signals supplied by the sensors.

5. The device of claim 1, wherein each input channel of the delay correlator has at least one sample-and-hold circuit for producing difference quotients of the analog signals of the input channels.

6. The device of claim 1, wherein the delay correlator has a binary output for a frequency-coded signal.

7. The device of claim 6, wherein the binary output is connected to a downstream counter for each edge change of the output signal.

8. The device of claim 1, wherein the adjusting circuit comprises a shift register.

9. The device of claim 8, wherein the number of shift register stages is variable with a constant clock frequency.

10. The device of claim 8, wherein the clock frequency is variable with a constant shift register length.

11. The device of claim 10, wherein a device for frequency generation on the basis of the DDFS (direct digital frequency synthesis) method is provided.

12. A delay correlator for measuring devices comprising at least two input channels which forms a closed control loop, a device for comparison of the time shift of input signals, a controller and an adjusting circuit for a parameter to be controlled by the controller and processing digital signals for determining the time shift of the input signals, and comprises a configurable FPGA.

13. The delay correlator of claim 12, wherein a digitizing device for input signals is provided in each input channel.

14. The delay correlator of claim 12, wherein a model delay serving as a parameter is controllable by the controller such that it is equal to the signal delay of the signals of the input channels.

15. The delay correlator of claim 12, wherein the device for determining the time shift of input signals comprises a phase detector, the output signal of which is a measure of the system deviation for activating the downstream controller.

16. The delay correlator of claim 12, wherein an electronic circuit which codes in binary form the algebraic signs of the difference quotient of the analog input signals is provided.

17. The delay correlator of claim 12, wherein each input channel has at least one sample-and-hold circuit for producing difference quotients of analog signals of the input channels.

18. The delay correlator of claim 12, wherein a binary output for a frequency-coded signal is provided.

19. The delay correlator of claim 18, wherein the binary output is connected to a downstream counter for each edge change of the output signal.

20. The delay correlator of claim 12, wherein the adjusting circuit comprises a shift register.

21. The delay correlator of claim 20, wherein the number of shift register stages is variable with a constant clock frequency.

22. The delay correlator of claim 20, wherein the clock frequency is variable with a constant shift register length.

23. The delay correlator of claim 22, wherein the device for frequency generation on the basis of the DDFS (direct digital frequency synthesis) method is provided.

24. A device for measuring the length of an object or endless material moving in a transporting direction, wherein a device for speed measurement of the object of claim 1 and a device for integrating its output signal are provided.

25. A device for controlling the speed or rotational speed of an object, wherein a delay correlator of claim 12 is provided, the adjusting circuit being set to a fixed value corresponding to the desired speed or rotational speed and the controller generating a control signal when there is a deviation from this desired speed.

26. A device for rotational speed measurement of a rotating object, wherein a delay correlator of claim 12 is provided, a sensor for scanning the rotating object being provided and being connected to two input channels of the delay correlator.
